(19) United States
(12) Patent Application Publication
(10) Pub. No.: US 2013/0007238 A1
(43) Pub. Date: Jan. 3, 2013

(54) RECOMMENDING RESOURCES

(76) Inventor: Thomas E. Sandholm, Sunnyvale, CA (US)

(21) Appl. No.: 13/173,087

(22) Filed: Jun. 30, 2011

(51) Int. Cl. G06F 15/173; G06F 17/30

(52) U.S. Cl. 709/223

(57) ABSTRACT

A subset of identifiers for resources is selected from a collection of identifiers for resources based on values associated with the different identifiers. Pairwise similarity scores between different pairs of identifiers in the subset then are computed. Based on these computed pairwise similarity scores, another subset of identifiers is identified from within the initial subset of identifiers as corresponding to resources perceived as potentially being of interest to a user for recommendation to the user.

### BACKGROUND

Recommendation systems may attempt to recommend new resources to an individual based on the popularity of the resources among other individuals. Recommendation systems that rely heavily on the popularity of resources in order to generate recommendations may suffer from a popularity bias, whereby the recommendation of popular resources to an individual may reinforce and strengthen the popularity of the recommended resources relative to other non-recommended resources. Consequently, over time, a small number of resources may become very popular, resulting in a limited pool of candidate resources from which to select recommendations and potentially leading to a situation where the same resources are recommended over and over again. Such lack of diversity in recommendations may diminish the value of a recommendation system, which, after all, is intended to introduce an individual to new resources, not the same old resources over and over again.

### BRIEF DESCRIPTION OF THE DRAWINGS

FIGS. 1A-1C illustrate examples of user interfaces for one example of a web page recommendation service displayed on a mobile computing device.

FIG. 2 is a block diagram of an example of a communications system.

FIGS. 3 and 4 are flowcharts that illustrate examples of processes for generating recommendations.

### DETAILED DESCRIPTION

A web page recommendation service tracks the web sites viewed by users of the service and enables users of the service to provide ratings of web pages that they view. In addition, the web page recommendation service may enable users to tag the ratings they provide (or the web pages they rate) as being related to a geographic location. In some cases, the default geographic location tagged to a rating may be the geographic location from which the user rated the web page. For example, if the user rates the web page using a global positioning system (GPS)-enabled device, the rating may be tagged by default to the GPS coordinates of the location of the device from which the user rated the web page as determined by the device used to rate the web page. Alternatively, the user may manually tag a rating to a particular geographic location, perhaps a geographic location the user associates with the web page being rated. For example, a user located in New York who is providing a rating for the home page for the Hewlett-Packard Company may know that the Hewlett-Packard Company is headquartered in. Palo Alto, Calif. and, therefore, tag his or her rating for the home page for the Hewlett-Packard Company to Palo Alto, Calif. even though the user is located in New York.

The web page recommendation service indexes the records of the web pages viewed and the web page ratings it receives according to the locations to which they are tagged. The web page recommendation service then uses the resultant geographically-indexed collection of web pages to generate location-based web page recommendations to users of the web page recommendation system. For example, the web page recommendation system may inform a user of the web pages considered to be most popular at the user's current location by determining which web pages received the highest number of page views and best ratings tagged to the user's current location.

Additionally or alternatively, the web page recommendation system may attempt to generate personalized web page recommendations for the user based on known preferences of the user in addition to the user's current location and the web pages that received the highest number of page views and best ratings tagged to the user's current location. In generating such personalized web page recommendations, the web page recommendation service employs techniques intended to increase recommendation diversity and to promote so-called serendipitous discovery of new web pages by the user. Such techniques may mitigate the effects of popularity bias potentially inherent in a recommendation service and, as a result, the web pages recommended to a user by the web page recommendation service may span a relatively wide range of popularity and may differ each time the web page recommendation service provides a personalized recommendation to the user, even if the user's location remains the same.

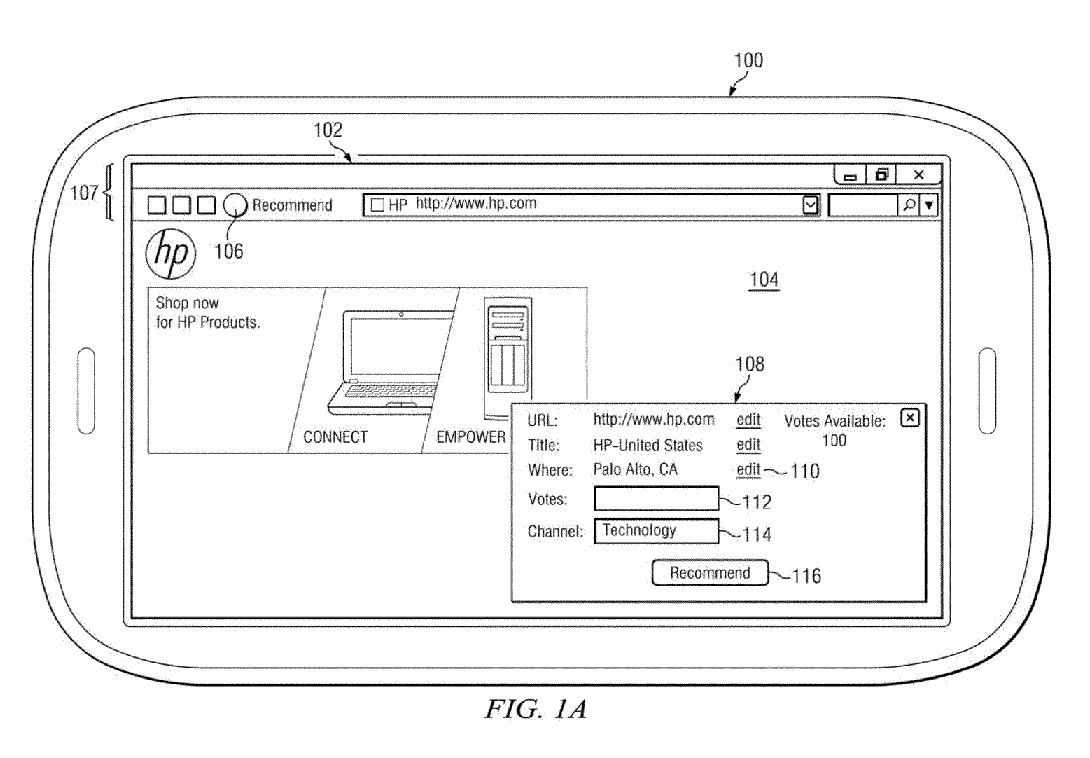

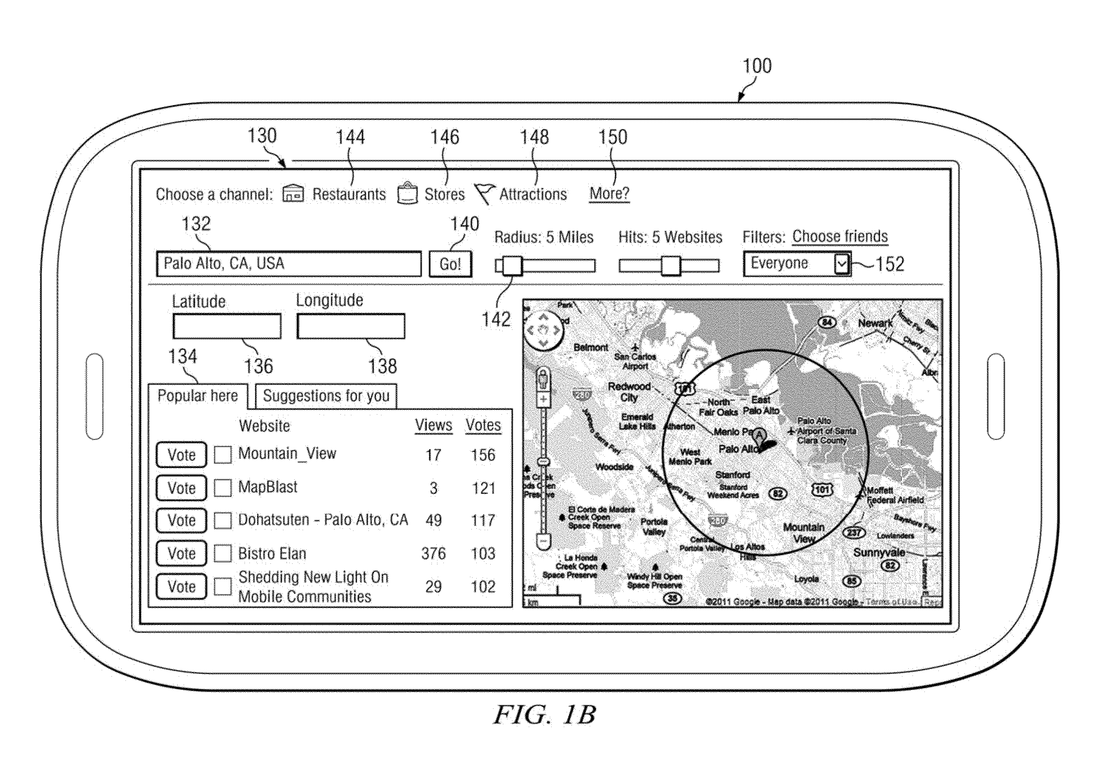

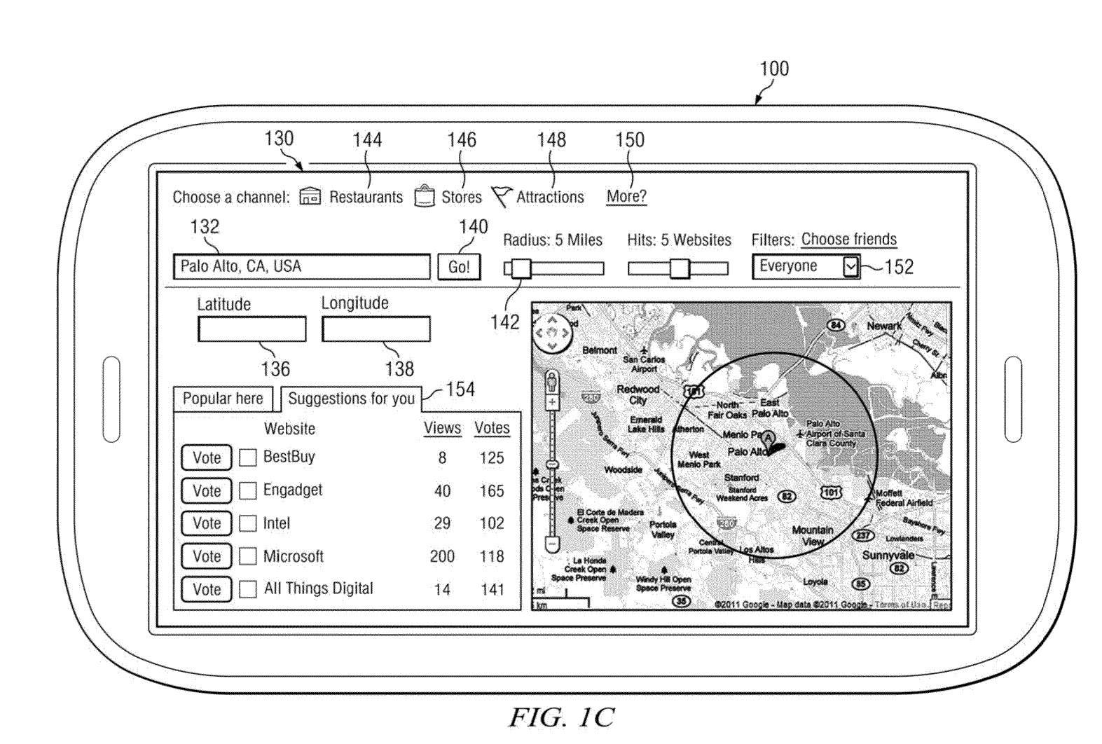

FIGS. 1A-1C illustrate examples of user interfaces for one example of a web page recommendation service displayed on a mobile computing device 100. As illustrated in FIG. 1A, mobile computing device 100 is displaying a graphical user interface (GUI) 102 for a web browser that is executing on mobile computing device 100 and that is being used to access the home page 104 for the Hewlett-Packard Company. In addition, a web browser plug-in (or another client application) installed on mobile computing device 100 to facilitate access to the web page recommendation service causes mobile computing device 100 to display a “Recommend” button 106 in the menu bar 107 of the web browser GUI 102.

The web browser plug-in is configured to track web pages viewed by a user of mobile computing device 100 and/or to enable a user of mobile computing device 100 to provide ratings of web pages that the user views using mobile computing device 100. For example, as illustrated in FIG. 1A, user invocation of “Recommend” button 106 triggers web browser plug-in to cause mobile computing device 100 to launch pop-up window 108 to enable the user of mobile computing device 100 to provide a rating for the web page currently being viewed, in this case the home page 104 for the Hewlett-Packard Company.

Pop-up window 108 includes an indication of the network address (or uniform resource locator (URL)) for the web page currently being viewed (i.e., http://www.hp.com) and an indication of the title of the web page currently being viewed (i.e., HP-United States). In addition, pop-up window 108 provides an indication of the current geographic location of the mobile computing device 100 (i.e., Palo Alto, Calif.) that, by default, will be tagged to the rating provided for the home page 104 for the Hewlett-Packard Company provided through pop-up window 108 by the user of mobile computing device 100 unless an alternative geographic location is specified by the user of mobile device (e.g., by invocation of selectable “Edit” control 110).

Pop-up window 108 also includes a “Votes” field 112 that enables the user of mobile computing device 100 to allocate a certain number of votes to the home page 104 for the Hewlett-Packard Company corresponding to the user's rating for the home page 104 for the Hewlett-Packard Company. In some implementations, the number of votes available to an individual user of the web page recommendation service may be budgeted so as to prevent the user from being able to contribute large numbers of votes to many different web pages thereby potentially inflating the rankings of these web pages. For example, as illustrated in FIG. 1A, the user of mobile computing device 100 has 100 votes available and can allocate anywhere from 0 to 100 votes to the home page 104 for the Hewlett-Packard Company depending on the user's impression of the home page 104 for the Hewlett-Packard Company by entering the appropriate number into “Votes” field 112.

Pop-up window 108 also enables the user of mobile computing device 100 to specify a category to be tagged to the rating for the home page 104 for the Hewlett-Packard Company in addition to the geographic location by specifying a category in the “Channel” field 114. In this case, the user of mobile computing device 100 has specified that the rating for the home page 104 for the Hewlett-Packard Company should be tagged with the category “Technology.”

After the user of mobile computing device 100 has entered information into pop-up window 108 to the user's satisfaction, invocation of “Recommend” button 116 causes the mobile computing device 100 to transmit the information entered into pop-up window 108, including, for example, the user's rating for the home page 104 for the Hewlett-Packard Company and the geographic location tagged to the rating, to the web page recommendation service.

The web page recommendation service tracks web page views by users of the web page recommendation service and records web page ratings received from users of the web page recommendation service. The web page recommendation service then compiles this data and uses it to generate location-based web page recommendations for users of the web page recommendation service.

FIG. 1B illustrates mobile computing device 100 displaying an example of a GUI 130 that facilitates user access to the web page recommendation service and that presents web pages to the user of the mobile computing device 100 for consideration based on the current location of the mobile computing device 100 (or, alternatively, based on a user specified location). More particularly, GUI 130 includes a location field 132 specifying a geographic location (i.e., Palo Alto, Calif., USA) and a “Popular here” tab 134 listing web pages deemed popular in Palo Alto, Calif. by the web page recommendation service.

The web page recommendation service may identify web pages as being popular in Palo Alto based on a combination of the number of tracked page views for different web pages by users of the web page recommendation system located in Palo Alto (or at a geographic location within some predetermined proximity of Palo Alto) and user ratings that were tagged to Palo Alto (or that were tagged to a geographic location that is within some predetermined proximity of Palo Alto). As such, the web pages listed in “Popular here” tab 134 may represent web pages that were viewed a relatively large number of times by users of the web page recommendation service located in Palo Alto and/or web pages that received relatively high user ratings (e.g., a large number of user votes) that were tagged to Palo Alto (or within some predetermined proximity of Palo Alto).

Mobile computing device 100 automatically may determine that it currently is located in Palo Alto, Calif. and pre-populate location field 132 with “Palo Alto, Calif., USA” based on this determination. However, if the user of mobile computing device 100 is interested in learning about web pages that are popular in other locations besides his or her own current location, he or she can enter a different location in location field 132 and/or specify different geographic coordinates in latitude field 136 and longitude field 138 and invoke “Go” button to trigger the web page recommendation service to present web pages deemed popular at the alternative location.

GUI 134 includes “Radius” control 142 that enables the user of mobile computing device 100 to control the geographic scope of the web pages presented to the user by the web page recommendation service. For example, by decreasing the radius using “Radius” control 142, the user may cause the web page recommendation service to more narrowly limit the web pages presented in “Popular here” tab 134 to web pages viewed by users within closer proximity to Palo Alto and/or to web pages having favorable user ratings tagged to geographic locations located more closely to Palo Alto. Similarly, by expanding the radius using “Radius” control 142, the user may cause the web page recommendation service to expand the web pages presented in “Popular here” tab 134 to web pages viewed by users further from Palo Alto and/or to web pages having favorable user ratings tagged to geographic locations located further from Palo Alto

GUI 130 also includes channel controls 144, 146, 148, and 150 that enable the user of mobile computing device 100 to filter the web pages listed in “Popular here” tab 134 by category, and user filter control 152 that enables the user of mobile computing device 100 to filter the web pages listed in “Popular here” tab 134 based on the identity of the users who provided user ratings and/or who viewed the web pages. For example, user filter control 152 may enable a user of mobile computing device 100 to filter the web pages listed in “Popular here” tab 134 based on one or more explicitly-specified co-users and/or one or more explicitly defined groups of co-users (e.g., defined social networks of co-users).

As illustrated in FIG. 1C, when “Suggestions for you” tab 154 is selected, the web page recommendation service causes a list of web pages to be displayed to the user of mobile computing device 100 that includes a personalized list of web pages recommended for the user by the web page recommendation service based on the user's current location (or a location manually entered by the user) and known preferences of the user. As described in greater detail below, as part of preparing such personalized web page recommendations for the user of mobile computing device 100, the web page recommendation service may employ techniques intended to increase recommendation diversity and to promote the serendipitous discovery of new web pages by the user of the mobile computing device 100.

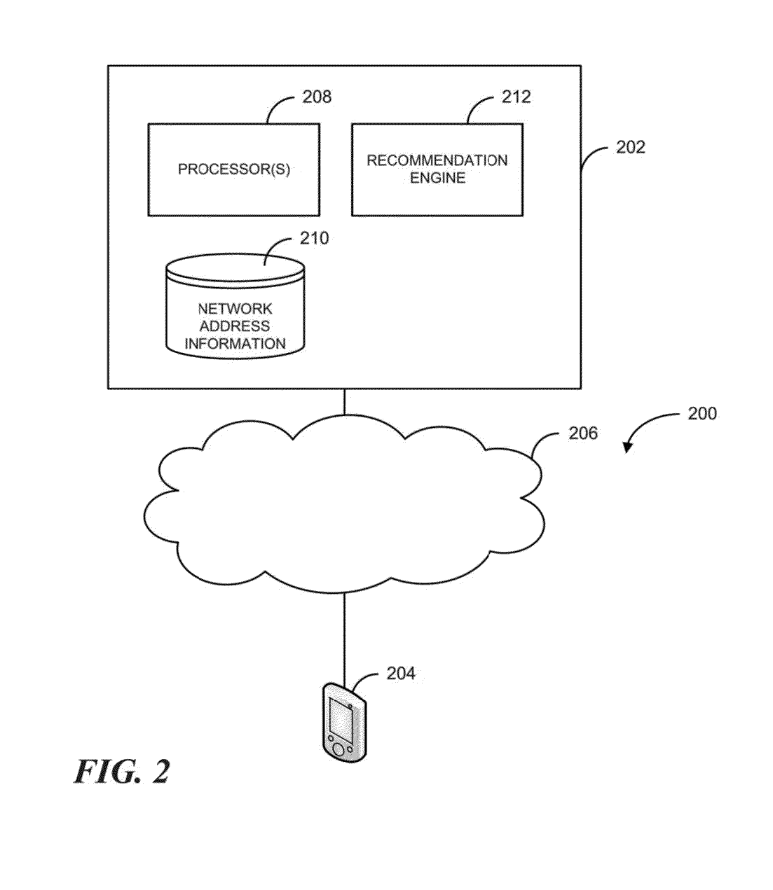

FIG. 2 is a block diagram of an example of a communications system 200 that includes a web page recommendation service computing system 202, a personal computing device 204, and a network 206 and that enables a human user of personal computing device 204 to access web page recommendation service computing system 202. For illustrative purposes, several elements illustrated in FIG. 2 and described below are represented as monolithic entities. However, these elements each may include and/or be implemented on numerous interconnected computing devices and other components that are designed to perform a set of specified operations and that are located proximally to one another or that are geographically displaced from one another.

Personal computing device 204 may be any of a number of different types of computing devices including, for example, a smartphone, a personal computer, a special purpose computer, a general purpose computer, a combination of a special purpose and a general purpose computing device, a laptop computer, a tablet computer, a netbook computer, a mobile phone, a personal digital assistant, and a portable media player. Personal computing device 204 typically has internal or external storage components for storing data and programs such as an operating system and one or more application programs. Examples of application programs include authoring applications (e.g., word processing programs, database programs, spreadsheet programs, or graphics programs) capable of generating documents or other electronic content; client applications (e.g., e-mail clients) capable of communicating with other computer users, accessing various computer resources, and viewing, creating, or otherwise manipulating electronic content; and browser applications capable of rendering Internet content. In addition, the internal or external storage components for personal computing device 204 may store a web browser plug-in or a dedicated client application for interfacing with web page recommendation service computing system 202. Alternatively, in some implementations, personal computing device 204 may interface with web page recommendation service computing system 202 without a specific client application (e.g., using a web browser).

Personal computing device 204 also typically includes a central processing unit (CPU) for executing instructions stored in storage and/or received from one or more other electronic devices, for example over network 206. In addition, personal computing device 204 also usually includes one or more communications devices for sending and receiving data. One example of such a communications device is a modem. Other examples include an antenna, a transceiver, a communications card, and other types of network adapters capable of transmitting and receiving data over network 206 through a wired or wireless data pathway.

Web page recommendation service computing system 202 may be implemented using one or more computing devices (e.g., servers) configured to provide a service to one or more client devices (e.g., personal computing device 204) connected to web page recommendation service computing system 202 over network 206. The one or more computing devices on which web page recommendation service computing system 202 is implemented may have internal or external storage components storing data and programs such as an operating system and one or more application programs. The one or more application programs may be implemented as instructions that are stored in the storage components and that, when executed, cause the one or more computing devices to provide the web page recommendation functionality and related features described herein.

Furthermore, the one or more computing devices on which web page recommendation service computing system 202 is implemented each may include one or more processors 208 for executing instructions stored in storage and/or received from one or more other electronic devices, for example over network 206. In addition, these computing devices also typically include network interfaces and communication devices for sending and receiving data.

Network 206 may provide direct or indirect communication links between web page recommendation service computing system 202 and personal computing device 204 irrespective of physical separation between any of such devices. As such, web page recommendation service computing system 202 and personal computing device 204 may be located in close geographic proximity to one another or, alternatively, web page recommendation service computing system 202 and personal computing device 204 may be separated by vast geographic distances. Examples of network 206 include the Internet, the World Wide Web, wide area networks (WANs), local area networks (LANs) including wireless LANs (WLANs), analog or digital wired and wireless telephone networks, radio, television, cable, satellite, and/or any other delivery mechanisms for carrying data.

As illustrated in FIG. 2, web page recommendation service computing system 202 includes computer memory storage system 210 storing network address information (e.g., page view tracking information and user-provided web page ratings). More particularly, computer memory storage system 210 may store a database recording information about web pages viewed by users of the web page recommendation service and web page ratings provided by users of the web page recommendation service. In one example, the database may be implemented as a table having multiple rows corresponding to individual web page views by users of the web page recommendation service, where each row is indexed by geographic location (e.g., according to the location from which the web page was viewed or, alternatively, according to a location specified by the user as corresponding to the web page) and records the network address of the web page viewed, an identifier for the user of the web page recommendation service who viewed the web page, an indication of the number of votes allocated to the web page (if any) by the user, and a time stamp reflecting the time at which the web page was viewed. Table 1 below provides an illustration of such an example database:

TABLE 1

| ROW | LOCATION TAG | NETWORK ADDRESS | USER ID | CATEGORY | VOTES | TIME STAMP |
|---|---|---|---|---|---|---|
| 1 | 37.45; -122.18 | http://www.hp.com | John_D | Technology | 10 | 2011-4-3T07:45 |
| 2 | 37.44; -122.13 | http://www.stanford.edu | J_Doe | Education | 0 | 2011-4-3T11:21 |
| 3 | 40.69; -74.05 | http://www.statueofliberty.org | Jane_Dough | Attraction | 6 | 2011-4-5T14:04 |
| 4 | 37.45; -122.18 | http://www.hp.com | John_D | Technology | 22 | 2011-4-5T15:59 |
| 5 | 40.85; -73.88 | http://www.bronxzoo.com | Jane_Dough | Attraction | 0 | 2011-4-5T18:30 |
| 6 | 40.72; -73.97 | http://www.hp.com | Janie_D | Technology | 0 | 2011-4-6T02:12 |
| . | | | | | | |
| . | | | | | | |
| . | | | | | | |
| n | 37.37; -122.04 | http://www.hpwebos.com | John_Doe | Technology | 9 | 2011-4-28T09:17 |

In the example illustrated in Table 1, each row in the table corresponds to an individual web page view by a user of the web page recommendation service and specifies (i) a network address corresponding to the web page viewed, (ii) a user identifier for the user who viewed the web page, (iii) a category tag for the web page viewed, (iv) an indication of the number of votes allocated to the web page by the user, and (v) a time stamp reflecting the time at which the user viewed the web page. In addition, each row of the table is indexed by a location tag—in this case represented by latitudinal and longitudinal coordinates—representing, for example, the location from which the user viewed the web page (and/or provided a rating for the web page) or, alternatively, the location to which the user tagged the rating the user provided for the web page.

In the event that a row in Table 1 represents a web page view by a user of the web page recommendation system who did not also provide a rating for the web page, a value of “0” may be recorded in the “Votes” column of the table. If however, a row represents both a web page view by a user of the web page recommendation system and a rating provided for the web page by the user, a value corresponding to the number of votes allocated to the web page by the user may be recorded in the “Votes” column. In this manner, Table 1 is capable of tracking both web page views by users of the web page recommendation service as well as web page ratings provided by users of the web page recommendation service.

As illustrated in Table 1, multiple different network addresses may be identified as corresponding to the same user of the web page recommendation system in a single table, each network address representing a separate web page view of and/or user rating for its corresponding web page by the user. For example, Table 1 reflects both http://www.statueofliberty.org and http://www.bronxzoo.com as corresponding to the user “Jane_Dough.” In addition, multiple instances of the same network address may be represented in a single table, each instance representing a separate page view of and/or user rating for the web page corresponding to the particular address. For example, there are three instances of http://www.hp.com in Table 1 representing three different page views and/or user ratings for the home page for the Hewlett-Packard Company available at http://www.hp.com. Furthermore, multiple instances of the same combination of network address and user identifier may be specified in a single table, each such instance representing a separate page view of and/or user rating for a given web page by the same user. For example, there are two instances of http://www.hp.com in Table 1 identified as corresponding to the user “John_D” representing two different page views and/or user ratings for the home page for the Hewlett-Packard Company available at http://www.hp.com by the user “John_D.”

The example database table illustrated in Table 1 and discussed above is only one example of how network address information may be stored in computer memory storage system 210. Of course, such network address information could be stored in a variety of different database configurations, or such network address information could be stored in a different type of data structure altogether. For example, Table 1 illustrates the network addresses as being geographically indexed according to latitudinal and longitudinal coordinates. However, in some implementations, instead of indexing the network addresses using longitudinal and latitudinal coordinates, the network addresses instead may be indexed according to geohash encodings of their latitudinal and longitudinal coordinates.

Web page recommendation service computing system 202 also includes a recommendation engine 212 that is configured to access the network address information stored in computer memory storage system 210 and provide web page recommendations to users of the web page recommendation, for example, based on the locations and/or known preferences of the users of the web page recommendation service as described in greater detail below. Recommendation engine 212 may be implemented as instructions stored in a computer memory storage system that, when executed, cause processor(s) 208 to provide the web page recommendation functionality and related features described herein.

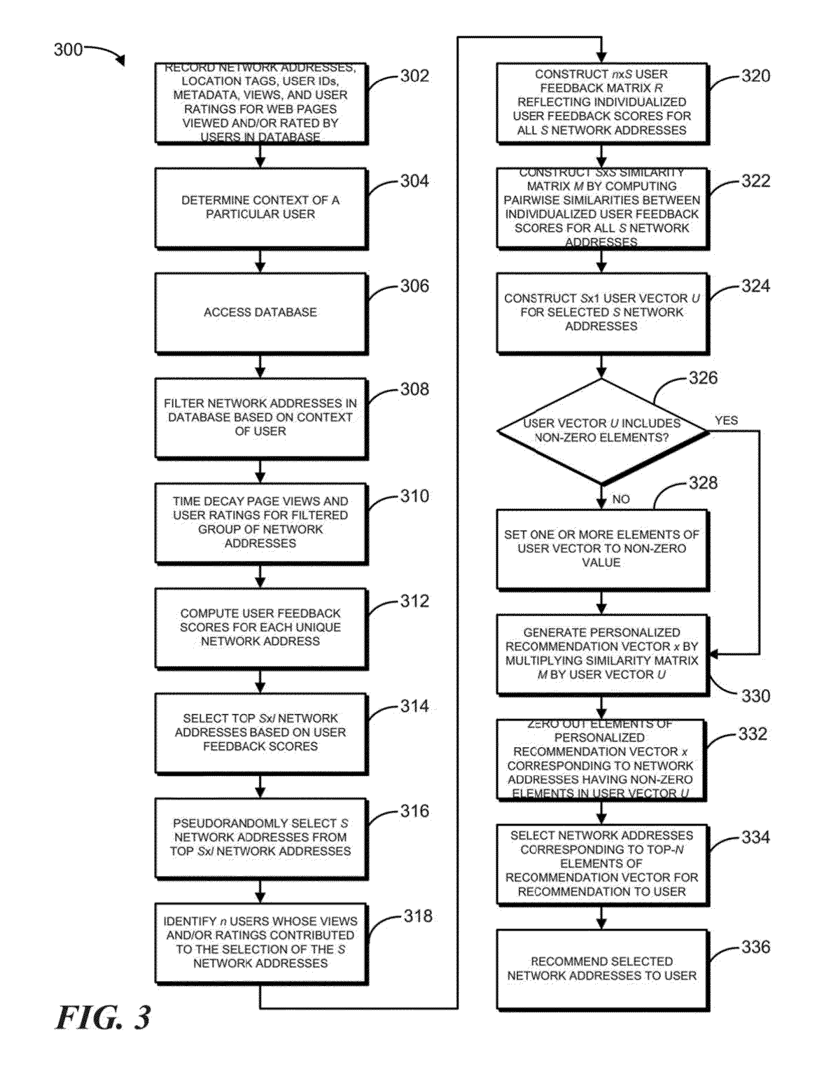

FIG. 3 is a flowchart that illustrates an example of a process for generating personalized web page recommendations. The process illustrated in the flowchart 300 of FIG. 3 may be performed by a web page recommendation service computing system such as the web page recommendation service computing system 202 illustrated in FIG. 2. More specifically, the process illustrated in the flowchart 300 of FIG. 3 may be performed by one or more of the processors 208 of the computing device(s) that implement the web page recommendation service computing system 202 under the control of one or more of recommendation engine 212 and other web page recommendation service modules.

At 302, as users of the web page recommendation service view web pages and/or provide ratings for web pages, the web page recommendation service records the network addresses of the web pages viewed and/or for which users have provided ratings in a database (e.g., a database implemented in computer memory storage system 210) along with corresponding location tags, user identifiers, and metadata about the web pages (e.g., categories assigned to the web pages).

At 304, a context of a particular user for whom the web page recommendation service is going to prepare personalized web page recommendations is determined. For example, a current geographic location of the user may be determined or a geographic location of interest to the user may be determined (e.g., as a consequence of manual entry of such geographic location by the particular user). Additionally or alternatively, the context of the user may be refined according to certain categories of interest to the user and/or according to certain co-users or groups of co-users whom the user is interested in.

At 306, the database storing the network addresses and other related data is accessed. Then, at 308, the network addresses stored in the database are filtered based on the determined context of the user. In one example, the network addresses are filtered down to a subset of network addresses having location tags that are within a defined distance of the current geographic location of the user (or within a defined distance of a geographic location of interest to the user). At this point, if multiple instances of the same network address are tagged to the same location or to locations that all are within the defined distance of the relevant geographic location, each separate instance may be retained. For instance, filtering Table 1 above by network addresses having location tags within proximity to Palo Alto may result in a subset that includes the network addresses of rows 1, 2, 4, 6, and n, all of which are tagged as being in Palo Alto or within a proximity of Palo Alto, but not all of which are unique. In this case, rows 1, 4, and 6 of Table 1 all specify the same network address, namely http://www.hp.com. Nevertheless, at this point, each instance of the network address http://Www.hp.com may be retained within the filtered subset. In addition or as an alternative to filtering the network addresses by location tag, the network addresses also may be filtered according to category tag and/or the user identifiers of the users who viewed and/or rated the web pages corresponding to the network addresses.

At 310, the page view counts and the user ratings for the network addresses of the filtered group of network addresses are time decayed based on the timestamps recording the times at which their corresponding web pages were viewed and/or rated. As discussed above, each entry in the filtered group of network addresses may represent a single page view of the web page corresponding to the network address. The value of the single web page view represented by an entry in the filtered group may be time decayed according to the time at which the page was viewed so that page views in the relatively distant past are accorded less weight than relatively recent page views. Equation 1 below may be used to calculate the time-decayed value of a page view:

$${C}_{t} = \frac{1}{{( 1 + r )}^{T}} \qquad ( Eq . 1 )$$

where t represents the present time, r represents a predefined decay rate per time step, T represents the number of time steps that have elapsed since the page view (e.g., days, weeks, months, etc.), and cₜ represents the value at the present time t of the page view that occurred at some time t-T in the past. The user rating values associated with network addresses in the filtered group of network addresses may be time-decayed similarly so that user ratings provided in the relatively distant past are accorded less weight than user ratings provided relatively recently. Equation 2 below may be used to calculate the time-decayed value for a user rating value:

$${v}_{t} = \frac{{v}_{t - T}}{{( 1 + r )}^{T}} \qquad ( Eq . 2 )$$

where t represents the present time, r represents a predefined decay rate per time step, T represents the number of time steps that have elapsed since the user rating was provided, and vₜ represents the value at the present time t of the user rating provided at some time t-T in the past.

After the values of the page views and user ratings for the network addresses in the filtered group of network addresses have been time-decayed, user feedback scores are computed for each unique network address in the filtered group of network addresses at 312. For a network address for which multiple instances are included in the filtered group, the user feedback score may be computed as a function of the time-decayed values of the page views and/or user ratings for each instance of the network address occurring in the filtered group of network addresses. For a network address for which only a single instance is included in the filtered group, the user feedback score may be computed as a function of the page view and/or user rating associated with the single instance of the network address.

In some implementations, the user feedback score for a network address may be computed as a linear combination of the time-decayed page view and user rating values associated with each instance of the network address in the filtered group of network addresses according to Equation 3 below.

s=αΣvₜ+(1−α)Σcₜ (Eq. 3)

where s represents the user feedback score for the network address, a represents a predefined constant such that 0≦α≦1, Σvₜ represents the sum of all time-decayed user rating values in associated with the network address in the filtered group, and Σcₜ represents the sum of all time-decayed page views associated with the network address in the filtered group. Alternatively, in other implementations, the user feedback scores may be strictly a function of the user ratings without taking into account the number of page views or strictly a function of page views without taking into account user ratings.

At 314, a number S×l of network addresses in the filtered group of network addresses having the highest user feedback scores are selected, where S represents a predetermined sample size, and where l>1 and represents a long-tail factor that controls the scope of the popularity of the network addresses included in the universe of network addresses from which the web page recommendation service draws recommendations. The larger the value of l selected, the greater the number of less popular network addresses that will be included in the universe of network addresses from which the web page recommendation service draws recommendations.

At 316, S network addresses are pseudorandomly selected from the previously selected S×l network addresses. Pseudorandomly selecting the S network addresses from the S×l top-rated network addresses instead of simply selecting the S top-rated network addresses from the filtered group may mitigate popularity bias and increase the likelihood of serendipitous discovery of new web pages by the user for whom the web page recommendation system is generating personalized recommendations.

After selecting the S network addresses, the n users whose web page views and/or ratings contributed to the ultimate selection of the S network addresses are identified at 318, and an n×S user feedback matrix R is constructed at 320, where each column of the matrix R represents an individual one of the S network addresses, each row of the matrix R represents an individual one of the n users, and the value of any element R_{i,j} of matrix R represents an individualized user feedback score attributable to, user i for network address j. In some implementations, the individualized user feedback score attributable to a user i for network address j may be computed according to Equation 4 below:

s_{i,j}=αΣvₜ_{_{i,j}}+(1−αΣcₜ_{_{i,j}} (Eq. 4)

where represents the individualized user feedback score attributable to user i for network address j, α represents a predefined constant, Σvₜ_{_{i,j}} represents the sum of all time-decayed user rating values provided by user i for network address j in the filtered group, and Σcₜ_{_{i,j}} represents the sum of all time-decayed page views by user i of the web page corresponding to network address j in the filtered group. Of course, if there are no web page views and/or user ratings attributable to user i for network address j within the filtered group, the value of s₁₁ may be 0.

At 322, an S×S similarity matrix M is constructed by computing pairwise similarities between the network addresses for all of the S selected network addresses, where each row represents an individual one of the S network addresses; each column represents an individual one of the S network addresses; the value of any element M_{i,j} of matrix M represents a measure of the similarity between (i) the network address represented by row i and (ii) the network address represented by column j; and the values for all M_{i,j} where i=j are set to 0. In some implementations, each of the n rows of matrix R may be normalized to be of unit length, and then Equation 5 below may be used to calculate a measure of the similarity between any two network, addresses i and j:

$$sim ( i , j ) = \frac{{\sum }_{∀ q : {R}_{q} > 0} {R}_{q , j}}{Freq ( i ) \times Freq ( j )} \qquad ( Eq . 5 )$$

where sim(i,j) represents a measure of the similarity between the network addresses i and j, and Freq(X) represents a measure of the combined number of web page views of and ratings provided for the web page corresponding to network address X.

At 324, an S×l user vector U is constructed, where each element in user vector U corresponds to an individual one of the S selected network addresses and reflects an individualized user feedback score for its corresponding network addresses that is attributable to the user for whom the personalized web page recommendations are being generated. In some implementations, construction of user vector U may be as simple as identifying a row within matrix R corresponding to individualized user feedback scores attributable to the user for whom the personalized web page recommendations are being generated and reformatting the identified row as a column vector. In some cases, the user for whom the personalized web page recommendations are being generated may not have viewed and/or provided a rating for any of the S selected network addresses. In such cases, all elements of user vector U may be set to 0.

At 326, a determination is made as to whether user vector U includes any non-zero elements. In the event that user vector U includes at least one non-zero element, the process skips 328 and proceeds to 330. Alternatively, if user vector U does not include any non-zero elements, at least one element in user vector U is set to a non-zero value (e.g., a low value) at 328, and then the process proceeds to 330.

At 330, an S×l personalized recommendation vector x is generated by multiplying similarity matrix M by user vector U such that x=MU where each element in x corresponds to an individual one of the S selected network addresses. Then, at 332, the elements of vector x that correspond to network addresses having non-zero values in user vector U (e.g., network addresses that the user for whom the personalized web page recommendations are being generated is known to have viewed and/or provided a rating for) are set to 0. For example, if the third element in user vector U has a non-zero value, then the third element in personalized recommendation vector x is set to 0.

At 334, the network addresses corresponding to the elements of personalized recommendation vector x having the N highest values are selected for recommendation to the particular user and, then, at 336, the selected network addresses are recommended to the particular user. Although the process illustrated in the flowchart 300 of FIG. 3 is tailored to generate personalized web page recommendations, the process may be generalized to generate personalized recommendations for any type of item including network resources such as web pages but extending to various other different types of items as well.

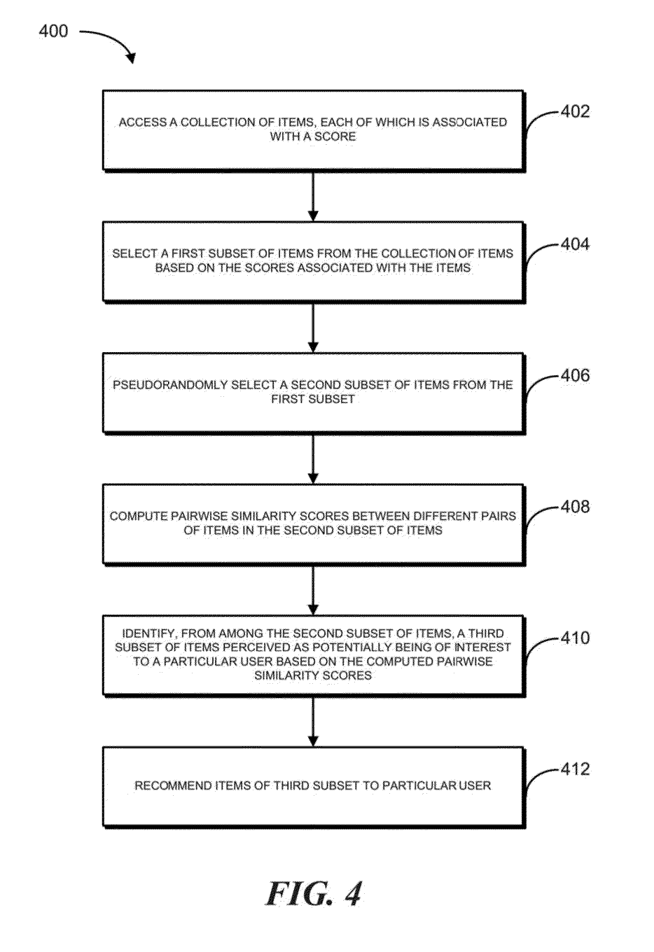

FIG. 4 is a flowchart 400 that illustrates a more general example of a process for generating personalized recommendations. The process illustrated in the flowchart 400 of FIG. 4 may be performed by a recommendation service computing system. More specifically, the process illustrated in the flowchart 400 of FIG. 4 may be performed by one or more of processors from one or more computing device(s) that implement the recommendation computing system under the control of one or more of a recommendation engine and other recommendation service modules.

At 402, a collection of items (e.g., network resources), each of which is associated with a score, is accessed (e.g., from a database). Then, at 404, a first subset of the items is selected from the collection of items based on the scores associated with the items. For example, some number S×l of the items having the top scores may be selected from the collection of items for inclusion in the first subset of items. At 406, a second subset of items is selected pseudorandomly from the first subset. For example, in implementations in which some number S×l of the items having the top scores are selected from the collection of items for inclusion in the first subset of items, S items may be selected from the first subset of items pseudorandomly for inclusion in the second subset of items.

After the second subset of items has been selected, pairwise similarity scores are computed between different pairs of items in the second subset of items at 408. For example, as described in connection with element 322 of FIG. 3, in some implementations, a user-item matrix may be constructed that reflects scores for individual ones of the items in the second subset of items that are attributable to individual users, and the user-item matrix then may be used to construct an item-item similarity matrix that reflects pairwise similarity scores for different pairs of items in the second subset of items based on the scores for the items attributable to individual users reflected in the user-item matrix.

At 410, a third subset of items that are perceived as potentially being of interest to the user for whom the personalized recommendations are being generated is identified from among the second subset of items based on the computed pairwise similarity scores. For example, the computed pairwise similarity scores may be used to identify items from among the second subset that are similar to items known to be of interest to the user for whom the personalized recommendations are being generated, and such items may be included within the third subset of items.

Then, at 412, the items of the third subset are recommended to the user for whom the personalized recommendations are being generated.

A number of methods, techniques, systems, and apparatuses have been described. However, additional implementations are within the scope of this disclosure. For example, the recommendation techniques described above generally are described as being performed by a host computing device in order to provide recommendations to a client computing device. However, in some implementations, the recommendation techniques described herein may be performed by a personal computing device (e.g., a smartphone, a personal computer, a laptop computer, a tablet computer, a netbook computer, a mobile phone, a personal digital assistant, or a portable media player) and resulting recommendations may be provided (e.g., displayed) to a user of the personal computing device.

The described methods, techniques, systems, and apparatuses may be implemented in digital electronic circuitry or computer hardware, for example, by executing instructions stored in computer-readable storage media.

Apparatuses implementing these techniques may include appropriate input and output devices, a computer processor, and/or a tangible computer-readable storage medium storing instructions for execution by a processor.

A process implementing techniques disclosed herein may be performed by a processor executing instructions stored on a tangible computer-readable storage medium for performing desired functions by operating on input data and generating appropriate output. Suitable processors include, by way of example, both general and special purpose microprocessors. Suitable computer-readable storage devices for storing executable instructions include all forms of non-volatile memory, including, by way of example, semiconductor memory devices, such as Erasable Programmable Read-Only Memory (EPROM), Electrically Erasable Programmable Read-Only Memory (EEPROM), and flash memory devices; magnetic disks such as fixed, floppy, and removable disks; other magnetic media including tape; and optical media such as Compact Discs (CDs) or Digital Video Disks (DVDs). Any of the foregoing may be supplemented by, or incorporated in, specially designed application-specific integrated circuits (ASICs).

Although the operations of the disclosed techniques may be described herein as being performed in a certain order and/or in certain combinations, in some implementations, individual operations may be rearranged in a different order, combined with other operations described herein, and/or eliminated, and the desired results still may be achieved. Similarly, components in the disclosed systems may be combined in a different manner and/or replaced or supplemented by other components and the desired results still may be achieved.

What is claimed is:

1. A system for providing a web page recommendation service comprising:
one or more processing elements; and
a computer memory storage system storing instructions that, when executed by the one or more processing elements, cause the one or more processing elements to:
access a database storing network addresses for web pages and corresponding indications of feedback generated by users of the web page recommendation service;
identify, from among the network addresses stored in the database, at least some network addresses as being relevant to a context of a particular user;
determine, based on indications of user-generated feedback corresponding to the network addresses identified as being relevant to the context of the particular user, scores for each of the network addresses identified as being relevant to the context of the particular user;
select, from the network addresses identified as being relevant to the context of the particular user and based on the scores determined for the network addresses identified as being relevant to the context of the particular user, a first subset of less than all of the network addresses identified as being relevant to the context of the particular user;
pseudorandomly select, from the first subset of network addresses, a second subset of less than all of the first subset of network addresses;
generate a network address similarity matrix specifying measures of pairwise similarity between network addresses of the second subset of network addresses;
determine if any indications of feedback generated by the particular user are stored in the database for the network addresses of the second subset of network addresses;
compute measures of perceived interest of the particular user in network addresses of the second subset of network addresses based on the network address similarity matrix and any indications of feedback generated by the particular user for the network addresses of the second subset of network addresses determined to be stored in the database;
identify, from the second subset of network addresses, network addresses for which no indications of feedback generated by the particular user are stored in the database;
select, from the network addresses identified as having no indications of feedback generated by the particular user stored in the database, a third subset of network addresses to recommend to the particular user based on the computed measures of perceived interest of the particular user in the network addresses for which no indications of feedback generated by the particular user are stored in the database; and
make the network addresses of the third subset available to the particular user.

2. The method of claim 1 wherein:
the instructions that, when executed by the one or more processing elements, cause the one or more processing elements to determine if any indications of feedback generated by the particular user are stored in the database for the network addresses of the second subset of network addresses include instructions that, when executed by the one or more processing elements, cause the one or more processing elements to determine that no indications of feedback generated by the particular user are stored in the database for the network addresses of the second subset of network addresses; and
the instructions that, when executed by the one or more processing elements, cause the one or more processing elements to compute measures of perceived interest of the particular user in network addresses of the second subset of network addresses include instructions that, when executed by the one or more processing elements, cause the one or more processing elements to:
generate a proxy for feedback generated by the particular user for at least one of the network addresses of the second subset of network addresses as a consequence of having determined that no indications of feedback generated by the particular user are stored in the database for the network addresses of the second subset of network addresses; and
compute measures of perceived interest of the particular user in network addresses of the second subset of network addresses based on the network address similarity matrix and the proxy for feedback generated by the particular user for the at least one network address of the second subset of network addresses.

3. A computer-implemented method comprising:
accessing, from a computer memory storage system, a collection of identifiers for resources, each identifier being associated with a user feedback score;
based on the user feedback scores associated with the identifiers, selecting, from the collection of identifiers and using a processing element, a first subset of unique identifiers that includes less than all of the identifiers from the collection of identifiers;
pseudorandomly selecting, from the first subset of identifiers and using a processing element, a second subset of less than all of the first subset of identifiers;
computing, using a processing element, pairwise similarity scores between different pairs of identifiers in the second subset of identifiers;
based on the computed pairwise similarity scores, identifying, from within the second subset of identifiers and using a processing element, a third subset of less than all of the second subset of identifiers corresponding to resources perceived as potentially being of interest to a user for recommendation to the user; and
making the third subset of identifiers available to the user.

4. The method of claim 3 wherein the resources are web pages and the identifiers for the resources are network addresses for the web pages such that:
accessing a collection of identifiers for resources comprises accessing a collection of network addresses for web pages, where each network address is associated with a user feedback score;
selecting, from the collection of identifiers, a first subset of unique identifiers based on the user feedback scores associated with the identifiers comprises selecting, from the collection of network addresses for web pages, a first subset of unique network addresses based on the user feedback scores associated with the network addresses;
pseudorandomly selecting, from the first subset of identifiers, a second subset of less than all of the first subset of identifiers comprises pseudorandomly selecting, from the first subset of network addresses, a second subset of less than all of the first subset of network addresses;
computing pairwise similarity scores between different pairs of identifiers in the second subset of identifiers comprises computing pairwise similarity scores between different pairs of network addresses in the second subset of network addresses;
identifying, from within the second subset of identifiers and based on the computed pairwise similarity scores, a third subset of less than all of the second subset of identifiers corresponding to resources perceived as potentially being of interest to a user comprises identifying, from within the second subset of network addresses and based on the computed pairwise similarity scores, a third subset of less than all of the second subset of network addresses corresponding to web pages perceived as potentially being of interest to a user; and
making the third subset of identifiers available to the user comprises making the third subset of network addresses available to the user.

5. The method of claim 4 wherein
the collection of network addresses for web pages includes multiple instances of the same network addresses, where each instance of a network address is associated with an individualized user feedback score;
selecting, from the collection of network addresses for web pages, a first subset of unique network addresses based on the user feedback scores associated with the network addresses includes:
computing, for each of at least some of the network addresses for which multiple instances are included in the collection of network addresses, an aggregate user feedback score based on individualized user feedback scores associated with at least some of the instances of the network address, and
selecting the first subset of unique network addresses based, at least in part, on the aggregate user feedback scores computed for network addresses for which multiple instances are included in the collection of network addresses.

6. The method of claim 5 wherein:
selecting, from the collection of network addresses for web pages, a first subset of unique network addresses includes selecting some number S x/of unique network addresses, where S represents the number of network addresses to be included in the second subset of network addresses and I>1; and
pseudorandomly selecting, from the first subset of network addresses, a second subset of less than all of the first subset of network addresses includes pseudorandomly selecting S network addresses from the first subset of network addresses.

7. The method of claim 4 wherein selecting, from the collection of network addresses for web pages, a first subset of less than all of the network addresses based on the user feedback scores associated with the network addresses includes:
computing time-decayed user feedback scores based on times associated with user feedback scores, and
selecting the first subset of less than all of the network addresses based on the computed time-decayed user feedback scores.

8. The method of claim 4 wherein identifying, from within the second subset of network addresses and based on the computed pairwise similarity scores, the third subset of less than all of the second subset of network addresses corresponding to web pages perceived as potentially being of interest to the user includes:
computing, based on the pairwise similarity scores and individual user feedback scores for network addresses in the second subset attributable to the user, measures of perceived interest of the user in web pages corresponding to network addresses in the second subset of network addresses; and
identifying, from within the second subset of network addresses, the third subset of network addresses based on the computed measures of perceived interest of the user in web pages corresponding to network addresses in the second subset of network addresses.

9. The method of claim 4 further comprising identifying, from within the second subset of network addresses, those network addresses for which the collection of network addresses includes no individual user feedback scores attributable to the user, wherein identifying, from within the second subset of network addresses, the third subset of network addresses based on the computed measures of perceived interest of the user in web pages corresponding to network addresses in the second subset of network addresses includes selecting, from among the identified network addresses of the second subset for which the collection of network addresses includes no individual rating values attributable to the user, the third subset of network addresses based on the computed measures of perceived interest of the user in web pages corresponding to network addresses in the second subset of network addresses.

10. The method of claim 4 further comprising receiving an indication of a location of interest to the user, wherein:
the collection of network addresses is indexed according to locations associated with the web pages that correspond to the network addresses; and
selecting, from the collection of network addresses, the first subset of unique network addresses based on the user feedback scores associated with the network addresses includes:
filtering the indexed collection of network addresses into a filtered collection of network addresses that are associated with locations within a defined vicinity of the location of interest to the user, and
selecting the first subset of network addresses from the filtered collection of network addresses based on the user feedback scores associated with the network addresses.

11. The method of claim 4 further comprising receiving an indication of a category of interest to the user, wherein:
the collection of network addresses is indexed according to categories associated with the web pages that correspond to the network addresses; and
selecting, from the collection of network addresses, the first subset of unique network addresses based on the user feedback scores associated with the network addresses includes:
filtering the indexed collection of network addresses into a filtered collection of network addresses that are associated with the category of interest to the user, and
selecting the first subset of network addresses from the filtered collection of network addresses based on the user feedback scores associated with the network addresses.

12. The method of claim 4 further comprising receiving an indication of a set of user identifiers corresponding to co-users of interest to the user, wherein:
individual network addresses within the collection of network addresses are associated with individual user feedback scores attributable to individual users who to are identified by user identifiers;
the collection of network addresses is indexed according to the user identifiers that correspond to the users to whom individual user feedback scores associated with the network addresses are attributable; and
selecting, from the collection of network addresses, the first subset of unique network addresses based on the user feedback scores associated with the network addresses includes:
filtering the indexed collection of network addresses into a filtered collection of network addresses that are associated with individual user feedback scores attributable to individual users identified by user identifiers within the set of user identifiers that correspond to co-users of interest to the user, and
selecting the first subset of network addresses from the filtered collection of network addresses based on the user feedback scores associated with the network addresses.

13. The method of claim 3 wherein making the third subset of identifiers available to the user comprises transmitting the third subset of identifiers to a client device.

14. The method of claim 3 wherein making the third subset of identifiers available to the user comprises causing representations of the third subset of identifiers to be displayed on a display device.

15. A non-transitory computer-readable storage medium storing instructions for providing a web page recommendation service that, when executed by a computer, cause the computer to:
access, from a computer memory storage system, a collection of network addresses for web pages, each network address being associated with a user feedback score that is a function of at least one of a number of views by users of the web page recommendation service of the corresponding web page and user-provided rating information for the corresponding web page, at least some of the user feedback scores associated with network addresses in the collection being functions of both numbers of views by users of the web page recommendation service of their corresponding web pages and user-provided rating information for their corresponding web pages;
based on the user feedback scores associated with the network addresses, select, from the collection of network addresses, a first subset of less than all of the network addresses;
compute pairwise similarity scores between network addresses in the first subset of network addresses;
based on the computed pairwise similarity scores, identify, from within the first subset of network addresses, a second subset of less than all of the first subset of network addresses corresponding to web pages perceived as potentially being of interest to a user for recommendation to the user; and
make the second subset of network addresses available to the user.
